(19) United States
(12) Patent Application Publication
(10) Pub. No.: US 2007/0183052 A1
(43) Pub. Date: Aug. 9, 2007

(54) Optical film, method for producing same, and polymer liquid crystal particle

(75) Inventors: Makoto Murata, Shizuoka (JP); Kensaku Higashi, Shizuoka (JP); Nobuhiro Kawatsuki, Hyogo (JP)

Correspondence Address: KNOBBE MARTENS OLSON & BEAR LLP, 2040 MAIN STREET, FOURTEENTH FLOOR, IRVINE, CA, 92614, US

(73) Assignee: TOMOEGAWA PAPER CO., LTD., Tokyo (JP)

(21) Appl. No.: 10/598,923

(22) PCT Filed: Mar. 17, 2005
(86) PCT No.: PCT/JP05/04752

§ 371 Date: Sep. 14, 2006

(30) Foreign Application Priority Data
Mar. 30, 2004 (JP) 2004-097992
Mar. 30, 2004 (JP) 2004-097993

(51) Int. Cl. G02B 27/00

(52) U.S. Cl. 359/613

(57) ABSTRACT

The present invention provides an optical film that can be suitably used for antiglare treatment to suppress blurry image and reduced contrast, as well as a method of producing such optical film. The optical film proposed by the present invention has a transparent base and a coating layer which is provided on at least one side of the transparent base and where transparent fine particles of 0.5 to 10 μm in average particle size are dispersed in a transparent resin phase, and one of the transparent resin phase or transparent fine particle contains a molecule-oriented high-molecular liquid crystal compound while the other is made of an optical isotropic resin.

### TECHNICAL FIELD

The present invention relates to an optical film exhibiting anisotropic scattering property that can be suitably used for liquid crystal displays (LCDs), plasma display panels (PDPs), CRTs, ELs and other image display devices, as well as a method of producing such optical film, and also relates to polymer liquid crystal fine particles made of a high-molecular material containing liquid crystal mesogens, to be used in the aforementioned optical film.

### BACKGROUND ART

Image display devices such as the aforementioned LCDs, PDPs, CRTs and ELs (hereinafter referred to as “displays”) are used in a wide range of fields including TV and computer and are undergoing remarkable innovation. In particular, LCDs have become immensely popular as slim, lightweight and versatile displays for use in personal computers, mobile phones, TVs, digital cameras, PDAs and various other devices.

When these displays are used in relatively bright areas such as outdoors and under fluorescent lamps, sunlight, fluorescent light and other external light reflect on the display. To prevent this unwanted reflection, manufacturers generally provide antiglare treatment on the display surface by means of forming irregularities to cause the entering external light to reflect irregularly on the surface.

This antiglare treatment is implemented by various methods, such as roughening the display surface via sandblasting, etc.; coating the display surface with transparent resin and then applying a forming film with irregular surface for forming treatment; or blending a coating material by dispersing clear fine inorganic or organic particles in a resin binder and then applying this coating material over the display surface to provide an antiglare layer.

Of the aforementioned technologies, the last one, or the antiglare treatment using a resin binder and clear fine organic particles, can cause external light to scatter on the surface due partly to the irregularities formed by the fine particles and partly to the differential refractive index between the resin binder and fine particle. In addition, if this technology is used on liquid crystal displays whose viewing angle is limited due to the display mechanism, image information output from the display can be scattered to enlarge the viewing angle. For the above reasons, this technology is currently the most commonly used antiglare treatment and applications of this technology are disclosed in, for example, Patent Literatures 1 through 3.

Although unwanted reflection on the display surface can be prevented, however, displays that have been given the aforementioned antiglare treatment also cause unnecessary scattering of image information output from inside the display. This gives rise to problems such as blurry image and reduced contrast.

To solve the aforementioned problems, the inventors studied industriously and found that blurry image and reduced contrast were caused by scattered emission, on the antiglare layer, of light entering the antiglare layer vertically from the display and light entering the layer at angles, as this scattered emission resulted in mixing of colors of two lights. Based on this finding, the inventors proposed an antiglare film that would disperse an optical anisotropic phase in an optical isotropic polymer phase to control the differential refractive index between the two phases and thereby prevent the image contrast from dropping.

However, the above method presented difficulty in terms of forming surface irregularities and therefore was short of providing sufficient antiglare performance against unwanted reflection of external light. Also, large variation in the shape and size of dispersed optical anisotropic phase sometimes caused blurry image.

Patent Literature 1: Japanese Patent No. 3314965

Patent Literature 2: Japanese Patent Laid-open Publication No. Hei 5-162261

Patent Literature 3: Japanese Patent Laid-open Publication No. Hei 7-181306

### SUMMARY OF THE INVENTION

Problems to Be Solved by the Invention

The present invention was developed to solve the aforementioned problems, and it is an object of the present invention to provide an optical film that can be suitably used for antiglare treatment by suppressing blurry image and reduced contrast while exhibiting a sufficient effect on preventing unwanted reflection of external light, and also provide a method of producing such optical film. It is another object of the present invention to provide polymer liquid crystal fine particles to be used in the production of the aforementioned optical film.

Means for Solving the Problems

To solve the aforementioned problems, the inventors studied industriously and found that blurry image and reduced contrast were caused by scattered emission, on the antiglare layer, of light entering the antiglare layer vertically from the display and light entering the layer at angles, as this scattered emission resulted in mixing of colors of the two lights. Scattering of light occurs on an interface of two phases, each having a different refractive index, and the degree of scattering varies depending upon the differential refractive index between the two phases. Accordingly, in the antiglare layer comprising a resin binder and clear fine organic particles, scattering is caused by the presence of the interface of a resin binder and clear fine organic particles, each having a different refractive index. Thus, the inventors have succeeded to suppress blurry image and reduced contrast on the display by keeping the differential refractive index between the two phases on the interface against light entering the antiglare layer vertically, but eliminating or reducing the differential refractive index on the interface against light entering at angles, leading completion of the present.

To be specific, the optical film proposed by the present invention has a transparent base and a coating layer which is provided on at least one side of the transparent base, said coating layer having transparent fine particles of 0.5 to 10 μm in average particle size dispersed in a transparent resin phase; wherein one of the transparent resin phase or transparent fine particle contains a molecule-oriented high-molecular liquid crystal compound while the other is made of an optical isotropic resin.

In the aforementioned optical film proposed by the present invention, the coating layer should desirably have an irregular surface whose average roughness (Ra) is 0.1 to 1.0 μm. Also, the transparent fine particles should desirably be spherical particles. Furthermore, the coating layer may be provided directly on the transparent base.

The first embodiment of the optical film proposed by the present invention is an optical film having a transparent base and a coating layer which is provided on at least one side of the transparent base and where transparent fine particles of 0.5 to 10 μm in average particle size made of an optical isotopic resin are dispersed in an optical anisotropic polymer phase made of a molecule-oriented high-molecular liquid crystal compound; wherein the direct transmittance of light with a wavelength of 550 nm entering the film surface at an angle of incidence of 30° is higher than the direct transmittance of light entering the film at an angle of incidence of 0°.

The second embodiment of the optical film proposed by the present invention is an optical film having a transparent base and a coating layer which is provided on at least one side of the transparent base and where optical anisotropic fine polymer particles of 0.5 to 10 μm in average particle size made of a high-molecular liquid crystal compound whose molecules have been oriented via application of heat or light or both are dispersed in an optical isotropic resin.

The optical film provided by the first embodiment of the present invention can be produced by a step of preparing a coating material by dissolving and dispersing in a solvent a high-molecular liquid crystal compound and transparent fine particles of 0.5 to 10 μm in average particle size made of an optical isotropic resin; a step of applying the coating material on a transparent base and volatilizing the solvent to form a coating layer where transparent fine particles are dispersed in a high-molecular liquid crystal compound phase; and a step of applying light or heat or both to orient the molecules of high-molecular liquid crystal compound.

The optical film provided by the second embodiment of the present invention can be produced by a step of preparing a coating material by dissolving and dispersing in a solvent an optical isotropic resin and transparent fine particles of 0.5 to 10 μm in average particle size made of a high-molecular liquid crystal compound; a step of applying the coating material on a transparent base and volatilizing the solvent to form a coating layer where fine particles made of high-molecular liquid crystal compound are dispersed in an optical isotropic resin phase; and a step of applying light or heat or both to orient the molecules of high-molecular liquid crystal compound.

The transparent fine particles made of a high-molecular liquid crystal compound (hereinafter referred to as “polymer liquid crystal fine particles”) used in the optical film provided by the second embodiment of the present invention, are fine particles of 0.5 to 10 μm in average particle size which are made of a high-molecular liquid crystal compound containing liquid crystal mesogens and whose molecules have been oriented via application of heat or light or both.

### EFFECT OF THE INVENTION

Generally with a film having a layer where fine particles are dispersed in a transparent resin phase, the direct transmittance of light with a wavelength of 550 nm entering the film is higher at an angle of incidence of 0° than at an angle of incidence of 30°. This is because light entering the film at an angle has a longer optical path in the film. As a result, more light passes the interface formed by the polymer layer and transparent fine particles, each having a different refractive index, and consequently light is caused to scatter more intensely.

On the other hand, the optical film proposed by the present invention has one of the transparent resin phase or transparent fine particle formed by an optical anisotropic polymer, while the other formed by an optical isotropic resin, to add characteristics opposite to those of general films. To be more specific, under the present invention one of the transparent resin phase or transparent fine particle is constituted by an optical anisotropic polymer, and refractive index nₓ or n_{y} in the in-plane direction of the transparent resin phase and refractive index n_{z}, in the normal direction are adjusted with respect to the refractive index of the transparent fine particle. This way, the differential refractive index between the transparent resin phase and transparent fine particle when light enters the film at 30° becomes smaller than the differential refractive index when light enters at 0°, and thus scattering of light entering at 30° becomes weaker than scattering of light entering at 0°. As a result, the direct transmittance of light entering at 30° becomes higher. In other words, the optical film proposed by the present invention can suppress mixing of colors by reducing the scattering of light entering at angles, because the differential refractive index of the transparent resin phase and transparent fine particle is greater when light enters straight ahead, while the differential refractive index becomes smaller when light enters at angles. This provides the effect of suppressing blurry image and reduced contrast. Accordingly, the optical film proposed by the present invention can be used suitably for the purpose of adding antiglare property to liquid crystal displays (LCDs), plasma display panels (PDPs), CRTs, ELs and other image display devices.

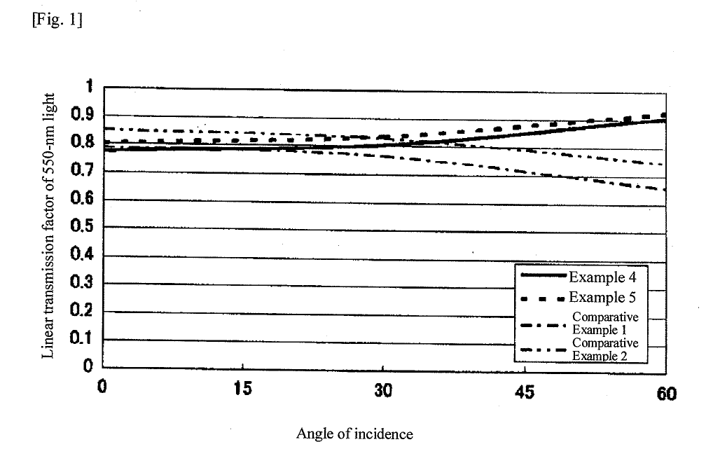

### BRIEF DESCRIPTION OF THE DRAWING

[FIG. 1] FIG. 1 is a graph illustrating how the direct transmittance of 550-nm light changes with respect to the angle of incidence, for the respective optical films provided in Examples 4 and 5 and Comparative Examples 1 and 2.

### BEST MODE FOR CARRYING OUT THE INVENTION

More favorable embodiments of the present invention are explained below in details. The transparent base used in the optical film proposed by the present invention may be any known clear film, glass, etc. Specific examples that can be suitably used include films made of polyethylene terephthalate (PET), polyethylene naphthalate (PEN), triacetyl cellulose (TAC), polymethyl methacrylate (PMMA), polycarbonate (PC), polyimide (PI), polyethylene (PE), polypropylene (PP), polyvinyl alcohol (PVA), polyvinyl chloride (PVC), cycloolefin copolymer (COC), norbomene-containing resin, polyether sulfone, cellophane, aromatic polyamide and various other resins, as well as silica glass, soda glass and other glass base materials. If the transparent base under the present invention is used for plasma display panels or liquid crystal displays, it is desirable to use one made of PET, TAC, COC or norbomene-containing resin, among others.

On top of the transparent base, a coating layer where transparent fine particles are dispersed in a transparent resin phase is provided directly or via another layer. One of the transparent resin phase or transparent fine particle is constituted by an optical anisotropic polymer, which is made of a molecule-oriented high-molecular liquid crystal compound, while the other is constituted by an optical isotropic resin. In this specification, “optical isotropy” refers to a property associated with a varying refractive index that changes depending on the measuring direction. It specifically refers to a case wherein the difference between refractive index nₓ or n_{y} in the in-plane direction of the film (nₓ and n_{y} indicate the maximum and minimum refractive indexes, respectively, in the in-plane direction of the film) and refractive index n_{z} in the normal direction, is 0.03 or more.

As for the high-molecular liquid crystal compound used in the transparent resin phase or transparent fine particle of the optical film proposed by the present invention, any compound can be used so long as its molecules have been oriented via application of heat or light or both. Among others, however, high-molecular liquid crystal compounds with a structure where mesogens and alkoxy groups, or mesogens and photoreactive groups, are included in the side chain are preferable. Among these high-molecular liquid crystal compounds, those having mesogens and cinnamoyl groups in the side chain are particularly preferable. This is because when light is initially irradiated onto a high-molecular liquid crystal compound having such structure, mesogens aligned in the direction roughly corresponding to the direction of electric field vector of the irradiated light are fixed by the optical dimerization reaction of cinnamoyl groups. When the high-molecular liquid crystal compound is subsequently heated, the remaining non-fixed mesogens move actively and become oriented in accordance with the fixed mesogens.

Next, high-molecular liquid crystal compounds that can be used favorably in the present invention are illustrated. These high-molecular liquid crystal compounds can be achieved by polymerizing a monomer compound having an acrylic group, vinyl group or other reactive function group at the end of each mesogen (hereinafter referred to as “low-molecular liquid crystal compound”). In the structural formulas presented below, “n” indicates the degree of polymerization. Desirable high-molecular liquid crystal compounds have an average molecular weight of 5000 to 1000000.

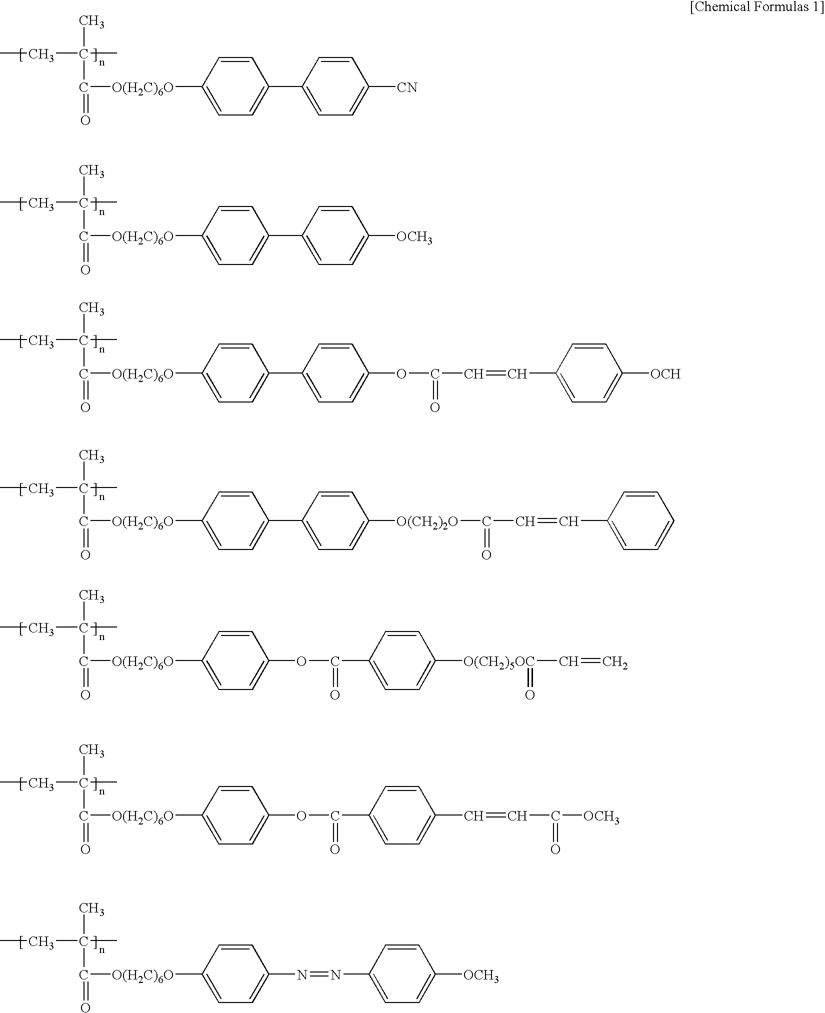

In addition to the high-molecular liquid crystal compounds illustrated above, it is also possible to use, for example, compounds made by copolymerizing two or more low-molecular liquid crystal compounds, or by copolymerizing a low-molecular liquid crystal compound with methyl methacrylate (MMA), styrene or other monomer compound not containing mesogens.

Under the present invention, if the transparent fine particles are polymer liquid crystal fine particles, then one method to produce these polymer liquid crystal fine particles comprises a step of adding to a water phase an oil phase containing one or more mesogen-containing polymeric monomers and a polymerization initiator, and then agitating the mixture to form droplet; and a step of polymerizing and fixing the polymeric monomer or monomers under agitation.

Another method to produce polymer liquid crystal fine particles conforming to the present invention comprises a step of producing a high-molecular liquid crystal compound by polymerizing one or more mesogen-containing polymeric monomers; a step of dissolving the obtained high-molecular liquid crystal compound in a solvent to make a solution; and a step of cooling the obtained solution to precipitate polymer liquid crystal fine particles.

Yet another method to produce polymer liquid crystal fine particles conforming to the present invention comprises a step of producing a high-molecular liquid crystal compound by polymerizing one or more mesogen-containing polymeric monomers; a step of dissolving the obtained high-molecular liquid crystal compound in a solvent to make a solution; and a step of atomizing the obtained solution into fine particles and then drying with hot air to collect polymer liquid crystal fine particles.

In addition to the methods presented above, any other method can be used to produce polymer liquid crystal fine particles conforming to the present invention, so long as the method is able to ultimately achieve polymer liquid crystal fine particles of 0.5 to 10 μm in average particle size.

As for the transparent resin phase or transparent fine particle, it is also possible to add other constituents to achieve desired characteristics, so long as the orientation characteristics of high-molecular liquid crystal compound is not lost. For example, polyacrylate, polymethacrylate, polystyrene and other compounds can be added to control orientation or improve thermal characteristics.

As for the optical isotropic resin used for the transparent resin phase of the optical film conforming to the present invention, thermoplastic resin, thermosetting resin, radiation-setting resin or other resins can be used as deemed appropriate. However, radiation-setting resin is preferable as it is easy to handle.

As for the type of radiation-setting resin, compositions made by mixing appropriate amounts of monomers, olygomers and prepolymers containing acryloyl groups, methacryloyl groups, acryloyloxy groups, methacryloyloxy groups, epoxy groups, vinyl ether groups, oxetane groups and other groups having polymeric unsaturated bonds or similar function groups can be used. Examples of monomers include methyl acrylate, methyl methacrylate, methoxy polyethylene methacrylate, cyclohexyl methacrylate, phenoxyethyl methacrylate, ethylene glycol dimethacrylate, dipentaerythritol hexaacrylate and trimethylol propane trimethacrylate, among others. Examples of olygomers and prepolymers include polyester acrylate, polyurethane acrylate, epoxy acrylate, polyether acrylate, alkyd acrylate, melamine acrylate, silicone acrylate and other acrylate compounds; unsaturated polyester, tetramethylene glycol diglycidyl ether, propylene glycol diglycidyl ether, neopentyl glycol diglycidyl ether, bisphenol A diglycidyl ether, various other alicyclic epoxys and other epoxy compounds; and 3-ethyl-3-hydroxy methyl oxetane, 1,4-bis{[(3-ethyl-3-oxetanyl)methoxy]methyl}benzene, di[1-ethyl(3-oxetanyl)]methyl ether and other oxetane compounds can be used. The above can be used alone or in combination.

If the transparent fine particles used in the optical film conforming to the present invention are made of an optical isotropic resin, then it is desirable that fine resin particles be used whose shape and refractive index can be controlled easily. As for the material to constitute fine optical isotropic resin particles, acrylic resin, silicone resin, styrene resin, melamine resin or styrene-acryl copolymer resin can be used, for example. Any resin can be selected freely in accordance with the desired reflective index, affinity and other properties to be achieved with respect to the optical isotropic polymer phase. Also, fine resin particles can be surface-treated using oils and greases, silane coupling agent, metal oxides and other organic or inorganic materials in order to improve dispersibility and further control refractive index.

The shape of the transparent fine particle is not specifically limited, but a spherical shape is preferred. Also, the average particle size must be in a range of 0.5 to 10 μm, or preferably in a range of 1 to 5 μm. If the average particle size is less than 0.5 μm, good light diffusivity cannot be achieved. If the average particle size exceeds 10 μm, on the other hand, the optical film exhibits granularity due to transparent fine particles, which is not desirable. The average particle size of the transparent fine particle used in the present invention is indicated as an average volumetric particle size obtained by the Coulter counter method.

Under the present invention, the content of transparent fine particles in the transparent resin phase should preferably be in a range of 0.5 to 20 percent by weight. Also, the film thickness of the layer where transparent fine particles are dispersed in a transparent resin phase should generally be set in a range of 0.5 to 50 μm, or more preferably in a range of 1 to 10 μm.

If the optical film proposed by the present invention is used as an antiglare film to prevent unwanted reflection of external light, it is desirable that the film surface have irregularities and that the average roughness Ra of this irregular surface be in a range of 0.1 to 1.0 μm. More preferably, Ra should be in a range of 0.1 to 0.5 μm. If Ra is smaller than 0.1 μm, reflection of external light cannot be prevented sufficiently. If Ra is greater than 1.0 μm, on the other hand, reflection can be prevented sufficiently but image becomes blurry, which is not desirable.

The optical film provided in the first embodiment of the present invention can be produced in the following manner. First, dissolve and disperse the aforementioned high-molecular liquid crystal compound as well as transparent fine particles made of an optical isotropic resin in chloroform or other appropriate solvent to prepare a coating material. Apply the obtained coating material on the aforementioned transparent base and volatilize the solvent to form a coating layer where transparent fine particles are dispersed in a high-molecular liquid crystal compound phase. Next, irradiate the formed coating layer with ultraviolet light or other light, heat the layer with a hot plate, etc., or apply both of these treatments, to orient the molecules of high-molecular liquid crystal compound, in order to form an optical anisotropic polymer phase and thus produce an optical film conforming to the present invention.

The optical film provided in the second embodiment of the present invention can be produced in the following manner. First, dissolve and disperse an optical isotropic resin as well as the aforementioned polymer liquid crystal fine particles in a solvent to prepare a coating material. Apply the obtained coating material on a transparent base and volatilize the solvent to form a coating layer where polymer liquid crystal fine particles are dispersed in an optical isotropic resin phase. Next, apply light or heat or both to the formed coating layer to orient the molecules of high-molecular liquid crystal compound, in order to form fine optical isotropic polymer particles and thus produce an optical film conforming to the present invention.

To form irregularities corresponding to an average roughness Ra of 0.1 to 1.0 μm on the surface of the optical film provided in the first or second embodiment of the present invention, the blending ratio of the high-molecular liquid crystal compound and transparent fine particles, or blending ratio of the optical isotropic resin and polymer liquid crystal fine particles, or thickness of the coating layer, should be adjusted in relation to the size of the fine transparent particle. In particular, the thickness of the coating layer should preferably be in a range of 100 to 120% of the size of the transparent fine particle.

The present invention is explained more specifically below using examples. It should be noted, however, that the present invention is not at all limited to these examples. Examples 1 through 3 illustrate production examples of polymer liquid crystal fine particles, while Examples 4 through 8 illustrate production examples of optical film. In the following paragraphs, “part(s)” means “part(s) by weight.”

### EXAMPLE 1

As a polymeric monomer, 3.0 g of the compound expressed by formula (1) below, 2.0 g of the compound expressed by formula (2) below, and 0.02 part of 2,2′-azobis(isobutyl nitrile) used as a polymerization initiator, were mixed in 200 ml of 0.10% aqueous polyvinyl alcohol solution at 5° C. to obtain a reaction solution of polymeric monomer.

This reaction solution of polymeric monomer was agitated using a homogenizing mixer operated at 5,000 rpm to prepare an emulsion of polymeric monomer. This emulsion was further agitated using a homogenizing mixer operated at 5,000 rpm in the presence of nitrogen to cause polymerization under heat at 80° C. for 5 hours. The resulting solution was filtered to obtain 4.3 parts of polymer liquid crystal fine particles. When the obtained polymer liquid crystal fine particles were observed using a scanning electron microscope, the particles had a spherical shape. The particle size measured by the Coulter counter method was 5.1 μm, and the average volumetric molecular weight measured by GPC was approx. 100000.
[Chemical Formulas 2]

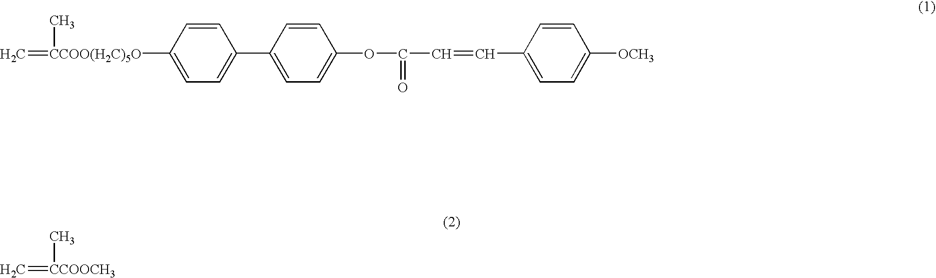

### EXAMPLE 2

As a polymeric monomer, 3.0 g of the compound expressed by formula (1) above, 2.0 g of the compound expressed by formula (2) above, and 0.02 g of 2,2′-azobis(isobutyl nitrite) used as a polymerization initiator, were mixed in 200 ml of THF at 5° C. to obtain a reaction solution of polymeric monomer. This reaction solution of polymeric monomer was agitated with a magnetic stirrer in the presence of nitrogen to cause polymerization under heat at 54° C. for 24 hours, and then cooled and filtered to obtain 4.1 g of white high-molecular liquid crystal compound. When measured by GPC, the average volumetric molecular weight of this high-molecular liquid crystal compound was approx. 80000.

Next, 2.0 g of the high-molecular liquid crystal compound was blended with 20 g of anisole and dissolved under heat at 80° C. to obtain a solution. The resulting solution was cooled to 5° C., and then filtered to obtain 1.9 g of polymer liquid crystal fine particles. When observed on a scanning electron microscope, the obtained polymer liquid crystal fine particles had an indeterminable shape, and their particle size was measured as approx. 2.3 μm by the Coulter counter method.

### EXAMPLE 3

2.0 g of the high-molecular liquid crystal compound obtained in Example 2 was dissolved in 40 g of chloroform to obtain a solution. Next, the solution was atomized by a spray dryer into droplet with a particle size of 10 μm, and then dried under hot air of 100° C. to obtain 0.6 g of polymer liquid crystal fine particles. When observed on a scanning electron microscope, the obtained polymer liquid crystal fine particles had a spherical shape, and their particle size was measured as approx. 4.0 μm by the Coulter counter method.

### EXAMPLE 4

A high-molecular liquid crystal compound comprising [poly(4-methoxy biphenyl oxyhexyl methacrylate)] (average molecular weight: 100000), transparent fine particles comprising transparent spherical fine particles made of styrene resin with an average particle size of 3.5 μm, and chloroform used as a solvent, were blended at the following blending ratios and dispersed for 30 minutes in a sand mill to prepare a coating material.

(Blending ratios)

High-molecular liquid crystal compound: 5 parts
Transparent fine particles: 0.5 part
Chloroform: 100 parts

The obtained coating material was applied by the spin coating method on a transparent base made of PET with a film thickness of 74 μm and transmission factor of 92%, and then dried to form a coating layer of 3.7 μm in thickness on top of the transparent base. Next, the film with a coating layer was heated on a hot plate (heating condition: 110 C. for 10 minutes) to orient the molecules of high-molecular liquid crystal compound to produce an optical film. Ra of the optical film was 0.5 μm.

### EXAMPLE 5

A high-molecular liquid crystal compound comprising [poly(4′-(4-methoxy cinnamoyl)4-biphenyl oxyhexyl methacrylate)] (average molecular weight: 80000), transparent fine particles comprising transparent spherical fine particles made of acrylic resin with an average particle size of 3.0 μm, and chloroform used as a solvent, were blended at the following blending ratios and dispersed for 30 minutes in a sand mill to prepare a coating material.

(Blending ratios)

High-molecular liquid crystal compound: 5 parts
Transparent fine particles: 0.5 part
Chloroform: 100 parts

The obtained coating material was applied by the spin coating method on a transparent base made of PET with a film thickness of 75 μm and transmission factor of 92%, and then dried to form a coating layer of 3.2 μm in thickness on top of the transparent base. Next, the film with a coating layer was irradiated with non-polarized ultraviolet light from directly above using UV spot light source (irradiation condition: 150 mW/cm² for 10 seconds), after which the film was heated on a hot plate (heating condition: 130° C. for 5 minutes) to orient the molecules of high-molecular liquid crystal compound to produce an optical film. Ra of the optical film was 0.3 μm.

### COMPARATIVE EXAMPLE 1

Instead of a high-molecular liquid crystal compound, PMMA (average molecular weight: 40000) was blended with transparent fine particles comprising transparent spherical fine particles made of styrene resin with an average particle size of 3.5 μm, and chloroform used as a solvent, at the following blending ratios and dispersed for 30 minutes in a sand mill to prepare a coating material.

(Blending ratios)

MMA: 5 parts
Transparent fine particles: 0.5 part
Chloroform: 100 parts

The obtained coating material was applied by the spin coating method on a transparent base made of PET with a film thickness of 75 μm and transmission factor of 92%, and then dried to form a coating layer of 3.7 μm in thickness on top of the transparent base and thus produce an optical film for comparison.

### COMPARATIVE EXAMPLE 2

Instead of a high-molecular liquid crystal compound, PMMA (average molecular weight: 40000) was blended with transparent fine particles comprising transparent spherical fine particles made of acrylic resin with an average particle size of 3.0 μm, and chloroform used as a solvent, at the following blending ratios and dispersed for 30 minutes in a sand mill to prepare a coating material.

Blending ratios)

PMMA: 5 parts
Transparent fine particles: 0.5 part
Chloroform: 100 parts

The obtained coating material was applied by the spin coating method on a transparent base made of PET with a film thickness of 75 μm and transmission factor of 92%, and then dried to form a coating layer of 3.2 μm in thickness on top of the transparent base and thus produce an optical film for comparison.

Next, Examples 4 and 5 and Comparative Examples 1 and 2 were evaluated based on the following methods.

(Measurement of dependence of linear optical transmission factor on angle of incidence) Using a spectrophotometer, the direct transmittance of 550-nm light entering each optical film at an angle of incidence of 0 to 60° was measured. The results are shown in FIG. 1.

As shown in FIG. 1, comparison of linear optical transmission factors at angles of incidence of 0° and 30° find that while the linear optical transmission factor at an angle of incidence of 30° is higher with the optical films obtained in Examples 4 and 5, the optical transmission factor at an angle of incidence of 0° is higher with the optical films obtained in Comparative Examples 1 and 2.

The optical films obtained in Examples 4 and 5 and Comparative Examples 1 and 2 were each attached on the surface of a LCD and image output from the LCD was observed. While the LCDs covered with the optical films obtained in Examples 4 and 5 showed clear, sharp image, the LCD covered with the optical film obtained in Comparative Example 1 showed undeniably blurry image with dull color, indicating that this optical film was unable to solve the problems of blurriness and poor contrast. The LCD covered with the optical film obtained in Comparative Example 2 also showed undeniably blurry image, indicating that this optical film was unable to solve the problem of blurriness.

### EXAMPLE 6

Pentaerythritol triacrylate was used as an optical isotropic resin, polymer liquid crystal fine particles obtained in Example 1 were used as polymer liquid crystal fine particles, 2-hydroxy-2-methyl propiophenone was used as a photoinitiator, and MIBK was used as a solvent, and the ingredients were blended at the following blending ratios and dispersed for 15 minutes in a sand mill to prepare a coating material.

(Blending ratios)

Optical isotropic resin: 100 parts
Polymer liquid crystal fine particles: 8 parts
Photoinitiator: 3 parts
Chloroform: 140 parts

The obtained coating material was applied by the reverse coating method on a transparent base made of PET with a film thickness of 75 μm and transmission factor of 92%, dried at 100° C. for 2 minutes, and then irradiated with ultraviolet light using a 120-W/cm focusing high-pressure mercury lamp (irradiation distance: 10 cm, irradiation time: 30 seconds) to cure the coating film and thus form a coating layer of 5.2 μm in thickness on top of the PET base.

Next, the film with a coating layer was irradiated with non-polarized ultraviolet light from directly above using a UV spot light source (irradiation condition: 150 mW/cm² for 10 seconds), after which the film was heated on a hot plate (heating condition: 130° C. for 5 minutes) to orient the molecules of high-molecular liquid crystal compound and thus produce an optical film.

### EXAMPLE 7

An optical film was produced in the same manner as in Example 6, except that the polymer liquid crystal fine particles obtained in Example 2 were used as polymer liquid crystal fine particles to form a coating layer of 3.1 μm in thickness.

### EXAMPLE 8

An optical film was produced in the same manner as in Example 6, except that the polymer liquid crystal fine particles obtained in Example 3 were used as polymer liquid crystal fine particles to form a coating layer of 4.3 μm in thickness.

### COMPARATIVE EXAMPLE 3

Pentaerythritol triacrylate was used as an optical isotropic resin, transparent spherical fine particles made of acrylic resin with an average particle size of 3.0 μm were used as polymer liquid crystal fine particles, 2-hydroxy-2-methyl propiophenone was used as a photoinitiator, and methyl isobutyl ketone was used as a solvent, and the ingredients were blended at the following blending ratios and dispersed for 15 minutes in a sand mill to prepare a coating material.

(Blending ratios)

Optical isotropic resin: 100 parts
Transparent spherical fine particles: 8 parts
Photoinitiator: 3 parts
Chloroform: 140 parts

The obtained coating material was applied by the reverse coating method on a transparent base made of PET with a film thickness of 75 μm and transmission factor of 92%, dried at 100° C. for 2 minutes, and then irradiated with ultraviolet light using a 120-W/cm focusing high-pressure mercury lamp (irradiation distance: 10 cm, irradiation time: 30 seconds) to cure the coating film and thus form a coating layer of 3.4 μm in thickness on top of the PET base, thereby producing an optical film for comparison.

### COMPARATIVE EXAMPLE 4

An optical film was produced in the same manner as in Comparative Example 3, except that transparent spherical fine particles made of styrene resin with an average particle size of 3.5 μm were used as polymer liquid crystal fine particles.

Next, Examples 6 through 8 and Comparative Examples 3 and 4 were evaluated based on the following methods.

(Measurement of contrast when viewed from directly in front)

The optical films obtained in Examples 6 through 8 and Comparative Examples 3 and 4 were each attached on the surface of a liquid crystal monitor, and contrast was measured using a color luminance meter (BM-7 manufactured by Topcon Corporation). For your reference, the greater the reading on the color luminance meter, the better the contrast.

(Evaluation of blurriness of image)

The optical films obtained in Examples 6 through 8 and Comparative Examples 3 and 4 were each attached on the surface of a liquid crystal monitor, and a still image displayed on the liquid crystal monitor was viewed from directly in front to check blurriness of the image. The evaluation criteria are as follows: A=Blurriness of image is not noticed, B=Blurriness of image is noticed.

The evaluation results are summarized in Table 1 below.

TABLE 1

| | Contrast measured from | Blurriness |
|---|---|---|
| | directly in front | of image |
| Example 6 | 518 | A |
| Example 7 | 495 | A |
| Example 8 | 525 | A |
| Comparative Example 3 | 361 | A |
| Comparative Example 4 | 520 | B |

As shown in Table 1, the optical films obtained in Examples 6 through 8 using polymer liquid crystal fine particles exhibited high contrast when viewed from directly in front, and blurriness of image was also minimal. On the other hand, the optical films obtained in Comparative Examples 3 and 4 produced a good result only for either contrast or blurriness of image.

1. An optical film having a transparent base and a coating layer which is provided on at least one side of the transparent base, said coating layer having transparent fine particles of 0.5 to 10 μm in average particle size dispersed in a transparent resin phase; the optical film characterized in that one of said transparent resin phase or transparent fine particle contains a molecule-oriented high-molecular liquid crystal compound and the other is made of an optical isotropic resin.

2. An optical film according to claim 1, characterized in that the coating layer has an irregular surface whose average roughness (Ra) is 0.1 to 1.0 μm.

3. An optical film according to claim 1, characterized in that the transparent fine particles are spherical particles.

4. An optical film according to claim 1, characterized in that the coating layer is provided directly on the transparent base.

5. An optical film according to claim 1, having a transparent base and a coating layer which is provided on at least one side of the transparent base and where transparent fine particles of 0.5 to 10 μm in average particle size made of an optical isotropic resin are dispersed in an optical anisotropic polymer phase made of a moleculc-oriented high-molecular liquid crystal compound, the optical film characterized in that the direct transmittance of light with a wavelength of 550 nm entering the film surface at an angle of incidence of 30° is higher than the direct transmittance of light entering the film at an angle of incidence of 0°.

6. An optical film according to claim 1, characterized by having a transparent base and a coating layer which is provided on at least one side of the transparent base and where optical anisotropic fine polymer particles of 0.5 to 10 μm in average particle size made of a high-molecular liquid crystal compound whose molecules have been oriented via application of heat or light or both are dispersed as transparent fine particles in an optical isotropic resin.

7. A method of producing the optical film of claim 5, characterized by comprising a step of preparing a coating material by dissolving and dispersing in a solvent a high-molecular liquid crystal compound and transparent fine particles of 0.5 to 10 μm in average particle size made of an optical isotropic resin; a step of applying said coating material on a transparent base and volatilizing the solvent to form a coating layer where transparent fine particles are dispersed in a high-molecular liquid crystal compound phase; and a step of applying light or heat or both to orient the molecules of high-molecular liquid crystal compound.

8. A method of producing the optical film of claim 6, characterized by comprising a step of preparing a coating material by dissolving and dispersing in a solvent an optical isotropic resin and transparent fine particles of 0.5 to 10 μm in average particle size made of a high-molecular liquid crystal compound; a step of applying said coating material on a transparent base and volatilizing the solvent to form a coating layer where transparent fine particles made of high-molecular liquid crystal compound are dispersed in an optical isotropic resin phase; and a step of applying light or heat or both to orient the molecules of high-molecular liquid crystal compound.

9. Polymer liquid crystal fine particles to be used in the optical film of claim 6, characterized by being transparent fine particles of 0.5 to 10 μm in average particle size which are made of a high-molecular liquid crystal compound containing liquid crystal mesogens and whose molecules have been oriented via application of heat or light or both.

10. Polymer liquid crystal fine particles according to claim 9, characterized in that the fine particles have a spherical shape.
